(19) United States
(12) Patent Application Publication
(10) Pub. No.: US 2009/0162246 A1
(43) Pub. Date: Jun. 25, 2009

(54) SAMPLE CARRYING APPARATUS CAPABLE OF REVOLVING SAMPLE

(76) Inventors: Chien-Chung FU, Hsinchu City (TW); Hsiu-Ming Chang, Hsinchu City (TW); Ann-Shyn Chiang, Hsinchu City (TW)

Correspondence Address: Muncy, Geissler, Olds & Lowe, PLLC, P.O. BOX 1364, FAIRFAX, VA, 22038-1364, US

(21) Appl. No.: 12/336,365

(22) Filed: Dec. 16, 2008

(30) Foreign Application Priority Data
Dec. 20, 2007 (TW) 096149044

(51) Int. Cl. B01J 19/00

(52) U.S. Cl. 422/63

(57) ABSTRACT

A sample carrying apparatus capable of revolving a sample includes a body and a revolvable structure. The body has a slot. The revolvable structure partially accommodated within the slot is pivotally connected to the body and is revolvable relative to the body.

This application claims priority of No. 096149044 filed in Taiwan R.O.C. on Dec. 20, 2007 under 35 USC 119, the entire content of which is hereby incorporated by reference.

### BACKGROUND OF THE INVENTION

1. Field of Invention

The invention relates in general to a sample carrying apparatus, and more particularly to a sample carrying apparatus capable of revolving a sample.

2. Related Art

Confocal laser scanning microscopy (CLSM or LSCM) is a valuable tool for obtaining high resolution images and 3-D reconstructions by using a spatial pinhole to eliminate out-of-focus light or flare. This technology permits one to obtain images of various Z-axis planes (Z-stacks) of the sample. The detected light originating from an illuminated volume element within the specimen represents one pixel in the resulting image. As the laser scans over the plane of interest, a whole image is obtained pixel by pixel and line by line. The beam is scanned across the sample in the horizontal plane using one or more (servo-controlled) oscillating mirrors. Information can be collected from different focal planes by raising or lowering the microscope stage. The computer can calculate and then generate a three-dimensional picture of the specimen by assembling a stack of these two-dimensional images from successive focal planes.

However, the Z-axis direction in the stacked 3D image has a much poor resolution (e.g., about 1.2 m/slice) than in the X-axis and Y-axis directions (about 0.15 m/pixel) under the limitation of the dimension of the pinhole and other mechanical or physical properties. A poor resolved Z-axis direction hampers the spatial reliability of the high resolution neural network images reconstructed, especially when comparison of two different samples is necessary. One of the inventors, Ann-Shyn Chiang, has disclosed an aqueous tissue clearing solution in U.S. Pat. No. 6,472,216 B1. In the '216 patent, the depth of observation may reach the level of micrometers. In the current developing method, fluorescent molecules are attached to or combined with the biological tissue. Thus, making the tissue become transparent is a key point for the break-through of the depth of observation, and the way of solving the bottleneck of the Z-axis resolution is greatly needed.

Thus, it is an important subject of the invention to provide a sample carrying apparatus capable of revolving the sample.

### SUMMARY OF THE INVENTION

It is therefore an object of the invention to provide a sample carrying apparatus capable of revolving a sample so that the resolution of 3D image sensing can be increased.

The invention achieves the above-identified object by providing a sample carrying apparatus capable of revolving a sample. The apparatus includes a body and a revolvable structure. The body has a slot. The revolvable structure partially accommodated within the slot is pivotally connected to the body and is revolvable relative to the body.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a sample carrying apparatus according to a preferred embodiment of the invention.

FIG. 2 is a front view showing a sample carrying apparatus according to a second embodiment of the invention.

FIG. 3 is a top view showing the sample carrying apparatus according to the second embodiment of the invention.

### DETAILED DESCRIPTION OF THE INVENTION

The present invention will be apparent from the following detailed description, which proceeds with reference to the accompanying drawings, wherein the same references relate to the same elements.

The present inventors have tried to revolve a sample by a specific angle about the X axis or the Y axis, and then to solve the problem of the too-low resolution along the Z axis by way of image processing and synthesizing. In order to achieve this effect, a sample carrying apparatus for carrying the sample has to be configured to be revolvable. In addition, the sample carrying apparatus has to hold a liquid, such as the saline solution or other solutions capable of making the biometrics organization become transparent, in order to carry the biometrics organization. The detailed structure of the sample carrying apparatus of the invention will be described in the following.

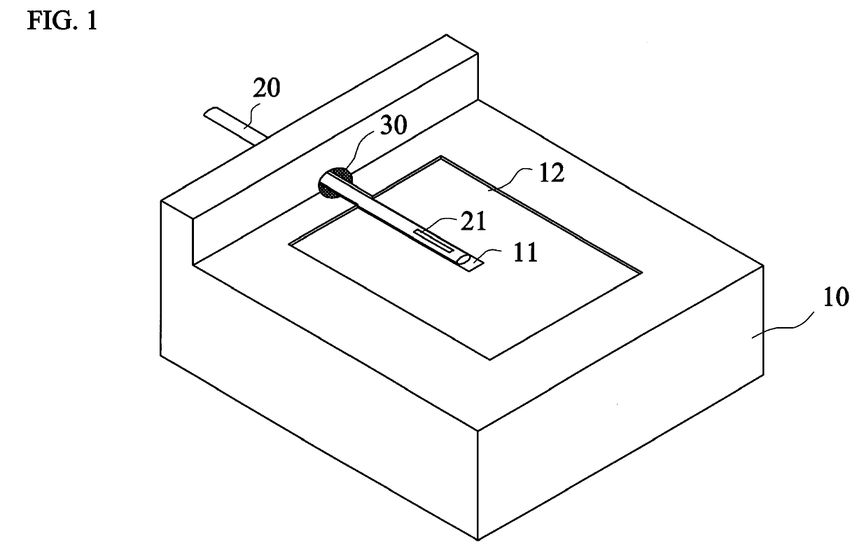

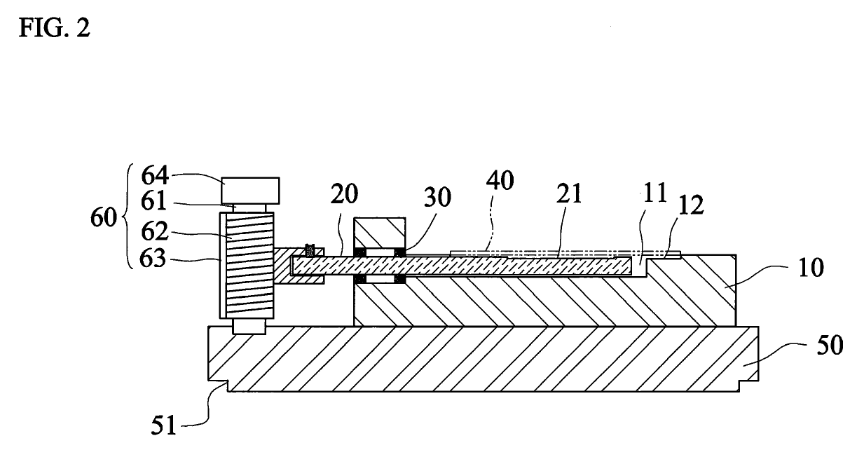

FIG. 1 is a schematic illustration showing a sample carrying apparatus according to a preferred embodiment of the invention. Referring to FIG. 1, the sample carrying apparatus includes a body 10 and one revolvable structure 20 or a plurality of revolvable structures. The body 10 has an L-shaped cross-sectional area (see FIG. 2). The body 10 has one slot 11 or a plurality of slots. The revolvable structure 20 partially accommodated within the slot 11 is pivotally connected to the body 10 and is revolvable relative to the body 10.

In this embodiment, the revolvable structure 20 is a rod-like structure, such as a cylinder. The rod-like structure has one plane 21 or a plurality of planes for supporting the sample. In order to immerse the sample in the liquid, such as a saline solution or a specific solution capable of making the sample become transparent, the revolvable structure 20 is pivotally connected to the body 10 through a sealing ring 30, which makes the liquid be held in the slot 11.

In order to seal the sample on the revolvable structure 20, the body 10 may have a concave portion 12 through which the slot 11 penetrates. The concave portion 12 may position and support a piece of cover glass 40.

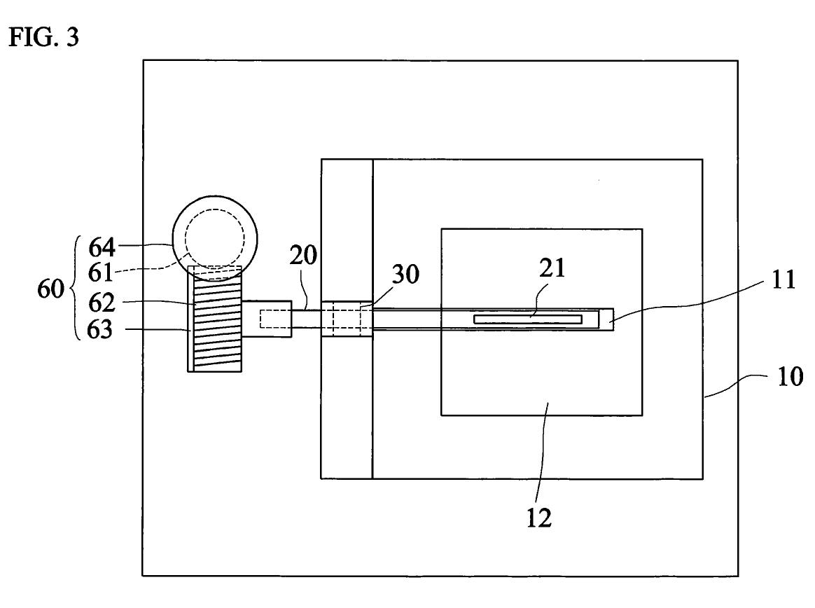

FIG. 2 is a front view showing a sample carrying apparatus according to a second embodiment of the invention. FIG. 3 is a top view showing the sample carrying apparatus according to the second embodiment of the invention. As shown in FIGS. 2 and 3, the sample carrying apparatus of this embodiment is similar to that of the first embodiment except that the sample carrying apparatus further includes a stage 50 and a driving device 60. The stage 50 supports the body 10. The driving device 60 is disposed on the stage 50 and is connected to the revolvable structure 20 to revolve the revolvable structure 20. The driving device 60 may be a motor (not shown).

In this embodiment, the driving device 60 includes a worm shaft 61 and a worm wheel 62, which is engaged with the worm shaft 61 and is revolved by the worm shaft 61. In order to make the user revolve the worm shaft 61 easily, the driving device 60 may further include a knob 64 fixed to the worm shaft 61, wherein the user may revolve the knob to revolve the worm wheel 62. In order to let the user know the revolving angle of the revolvable structure 20, the driving device 60 may further include a cover 63, which is fixed to the worm wheel 62 and is formed with indexes.

According to the sample carrying apparatus of the invention, the sample may be revolved. Thus, it is possible to reconstruct a three-dimensional object with high resolutions in three primary axes according to many stacks of images obtained at various revolving angles of the sample, wherein the revolving angles may be different from one another or each other by 90 degrees, for example. Thus, the resolutions may be increased, or other diversified image sensing functions may be achieved. In addition, the sample may be immersed in the liquid so that various sensing conditions may be satisfied.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A sample carrying apparatus, comprising:
a body having a slot; and
a revolvable structure, which is partially accommodated within the slot, is pivotally connected to the body and is revolvable relative to the body.

2. The sample carrying apparatus according to claim 1, wherein the revolvable structure is pivotally connected to the body through a sealing ring, and the sealing ring makes a liquid be held in the slot.

3. The sample carrying apparatus according to claim 1, wherein the revolvable structure is a rod-like structure having one plane or a plurality of planes for supporting a sample.

4. The sample carrying apparatus according to claim 1, wherein the body has a concave portion for positioning and supporting a piece of cover glass, and the slot penetrates through the concave portion.

5. The sample carrying apparatus according to claim 1, wherein the body has an L-shaped cross-sectional area.

6. The sample carrying apparatus according to claim 1, further comprising:
a stage for supporting the body.

7. The sample carrying apparatus according to claim 6, further comprising:
a driving device, which is disposed on the stage and is connected to the revolvable structure to revolve the revolvable structure.

8. The sample carrying apparatus according to claim 7, wherein the driving device comprises a motor.

9. The sample carrying apparatus according to claim 7, wherein the driving device comprises:
a worm shaft; and
a worm wheel, which is engaged with the worm shaft and is revolved by the worm shaft.

10. The sample carrying apparatus according to claim 9, wherein the driving device further comprises:
a cover, which is fixed to the worm wheel and is formed with indexes.

11. The sample carrying apparatus according to claim 9, wherein the driving device further comprises:
a knob, which is fixed to the worm shaft and is revolvable by a user to drive the worm shaft.
